(19) United States
(12) Patent Application Publication
(10) Pub. No.: US 2010/0112372 A1
(43) Pub. Date: May 6, 2010

(54) COMPONENT HAVING A CERAMIC BASE THE SURFACE OF WHICH IS METALIZED

(76) Inventor: Claus Peter Kluge, Roslau (DE)

Correspondence Address: FULBRIGHT & JAWORSKI, LLP, 666 FIFTH AVE, NEW YORK, NY, 10103-3198, US

(21) Appl. No.: 12/596,880

(22) PCT Filed: Apr. 17, 2008
(86) PCT No.: PCT/EP2008/054625

§ 371 Date: Oct. 21, 2009

(30) Foreign Application Priority Data
Apr. 24, 2007 (DE) 10 2007 019 635.2

(51) Int. Cl. B32B 3/30; B32B 18/00; B32B 15/04; B32B 3/26; B32B 5/18; B32B 3/00; C25D 7/00; B32B 5/00; C04B 37/02

(52) U.S. Cl. 428/600; 428/633; 428/450; 428/304.4; 428/613; 428/141; 205/50; 428/332; 428/627; 428/469; 428/472.2

(57) ABSTRACT

A component having a ceramic base the surface of which is covered in at least one area by a metalized coating, the ceramic base being spatially structured and the partial discharge resistance between at least two layers of a metalized structure produced from the same or different materials and between the layer of a metalized structure and the ceramic being <20 pC.

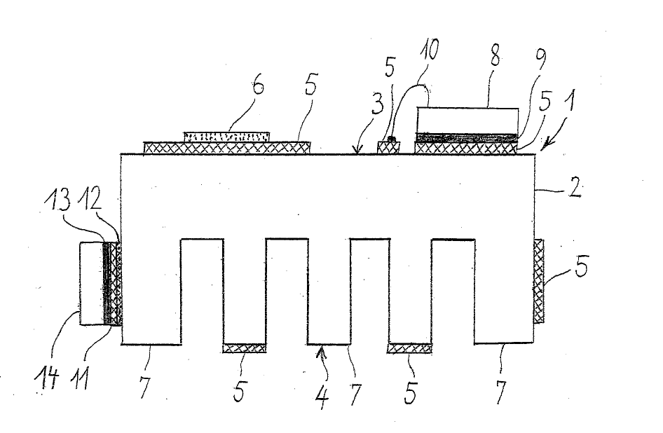

The invention relates to a component having a ceramic body which is covered in at least one region on its surface with a metallized coating.

With the advance of power electronics into ever higher voltage ranges, the demands for high insulation voltages and great partial-discharge resistance are intensifying. The insulation and partial-discharge resistance is dependent inter alia upon the thickness, material and homogeneity of the base insulation, the housing material and filling material and, if applicable, also the chip arrangement.

Load-changes with frequencies below approximately 3 kHz and above all during intermittent operation, as is predominant, for example, in traction, lifting and pulsed applications, result in a temperature-change stress of the internal module connections, that is, the bonded connections, the rear-side soldering of the chips, the DCB/base-plate soldering and the substrate lamination (Cu on Al₂O₃ or AlN). The different coefficients of linear expansion of the individual layers give rise to thermal distortions during manufacture and during operation, which ultimately lead to material fatigue and wear. The length of the service life (number of possible switching cycles) drops with rising amplitude of the fluctuation in the chip temperature during these cycles.

A plate-shaped metal-ceramic substrate which reliably observes a partial-discharge resistance of <10 pC is known from DE 10 2004 033 227 A1.

The object of the invention consists in putting forward a component with a ceramic body that is metallized on its surface and which is not exclusively plate-shaped, planar, and has high partial-discharge resistance.

The object is achieved with the aid of the characterising features of claim 1. Advantageous developments of the invention are put forward in the dependent claims.

The component in accordance with the invention is spatially structured. Instead of a plate, the ceramic body has a three-dimensional structure. Thus, for example, further portions can continue from a plate so that a body of any form develops. The whole body, however, is in one piece, that is, it is not composed of individual parts. If, for example, further plates stand perpendicularly on a plate, a whole body that is E-shaped can develop, for example. Heat sinks, for example, have such a form.

In accordance with the invention the partial-discharge resistance between at least two layers of a metallized coating of the same kind of or different materials as well as between the layer of a metallized coating and the ceramic material is <20 pC. This partial-discharge resistance, depending on the predetermined same or different measuring method, is achieved with the same or not the same or a changing predetermined measurement voltage or the same or not the same or changing measurement conditions. Measurement conditions can be, for example, pressure or temperature or air moisture or the same or not the same distances between the metallized coatings.

When the metallized coating is put on the ceramic body or metallized coatings are put one on top of the other, blisters and cavities and also detached portions can form in the edge region. The same applies to the transition between a connected component and the metallized coating. These defects at the transition between two metallized coatings and also a metallized coating and the ceramic body or a connected component and the metallized coating have a harmful effect upon the partial-discharge resistance. So that the required partial-discharge resistance of <20 pC is not exceeded, these defects may not go beyond a diameter of 100 μm and a height of 100 μm. The diameter describes a projection, inscribed in a circle, of a defect formed in any way.

Moreover, the defects that are formed by the structuring of the metallized coating in the form of projections or recesses on the surface of the component affect the partial-discharge resistance on account of the disturbance of the electric field at these points. For this reason, these defects may only have an edge course whose radius of curvature does not fall short of 10 μm so that the required partial-discharge resistance of <20 pc is not exceeded.

Metals in the form of coatings or foils or metal sheets are preferably attached as the metallized coating to the ceramic body over the whole or part of the surface in a substance-locking manner or by means of mechanical form-locking, the metals having the same or different thermal conductivity as or from the ceramic body. The metallized coating can, for example, consist of tungsten, silver, gold, copper, platinum, palladium, nickel, aluminium or steel of pure or industrial quality or of mixtures of at least two different metals. The metallized coating can, for example, also, additionally or merely, consist of reaction solders, soft solders or hard solders.

Adhesion-promoting substances or other additives, such as, for example, glasses or polymeric materials, can be added to or used to coat the metals of the metallized coating in the form of coatings or foils or metal sheets in order to increase the adhesiveness of the metallized coating on the ceramic body.

The layer or layers of the metallized coating is or are put on the surface of the body on opposing and/or adjacent faces with use of a DCB (direct copper bonding) method or an AMB (active metal brazing) method or a screen-printing method or an electrolytic method or chemical deposition or a vaporization method or by means of adhesion or gluing or a combination of these methods.

The metallized coating on the ceramic body consists of at least one layer per metallized face. The metallized coating covers the surface of the ceramic body as a metal body over part of or the whole surface or partly or completely in a plane-parallel or almost plane-parallel form or in a manner protruding in any geometrical form or in combinations of the forms.

The layer thickness of a metallized coating should lie below 2 mm so that the required partial-discharge resistance of <20 pC is not exceeded.

One or more metallized coatings on the ceramic body can consist exclusively of copper. The connection with the ceramic body is effected by means of the screen-printing method with subsequent thermal treatment or the DCB method.

One or more metallized coatings on the ceramic body can consist exclusively of aluminium. The connection with the ceramic body is effected by means of the screen-printing method with subsequent thermal treatment or by means of the AMB method.

If a further layer is to be applied to the surface of the ceramic body or a metallized coating, it can be advantageous to put on an intermediate layer to promote adhesion. Such an intermediate layer preferably has a thickness of ≦20 μm. If, for example, a metallized coating of copper is to be put onto an aluminium-nitride ceramic material by means of the DCB method, it is advantageous if an intermediate layer of Al₂O₃ is generated on the surface of the ceramic body. As a result, the adhesive strength of the metallized coating with copper is increased.

The binding of the at least one metallized coating and/or a further metallized coating to the ceramic body is >90%.

The at least one metallized coating is connected to the ceramic body with an adhesive strength of at least 12 N/cm. As a result, it is guaranteed that in particular as a result of the thermal loading no detachment of the metallized coating from the ceramic body occurs.

The body of the component consists of a ceramic material which can be matched in its composition to the required properties, for example insulation, partial-discharge resistance and thermal stability.

The ceramic material contains as a main component 50.1% by weight to 100% by weight ZrO₂/HfO₂ or 50.1% by weight to 100% by weight Al₂O₃ or 50.1% by weight to 100% by weight AlN or 50.1% by weight to 100% by weight Si₃N₄ or 50.1% by weight to 100% by weight BeO, 50.1% by weight to 100% by weight SiC or a combination of at least two of the main components in any combination in the specified range of proportions and also as a secondary component the elements Ca, Sr, Si, Mg, B, Y, Sc, Ce, Cu, Zn, Pb in at least one oxidation stage and/or compound with a proportion of ≦49.9% by weight individually or in any combination in the specified range of proportions. The main components and the secondary components, with removal of a proportion of impurities of ≦3% by weight, can be combined with each other in any combination with each other to give a total composition of 100% by weight.

The ceramic body of the component is preferably formed as a heat sink. What is understood by a heat sink is a body which bears electrical or electronic structural elements or circuit arrangements and which is formed in such a way that it can dissipate the heat that develops in the structural elements or circuit arrangements in such a way that no accumulation of heat develops that can do damage to the structural elements or circuit arrangements. The carrier body is a body made from a material which electrically is not or is almost not conductive and has good thermal conductivity. The ideal material for such a body is ceramic material.

The body is in one piece and has heat-dissipating or heat-supplying elements to protect the electronic structural elements or circuit arrangements. The carrier body is preferably a printed circuit board, and the elements are bores, channels, ribs and/or clearances on which a heating or cooling medium can act. The medium can be liquid or gaseous. The carrier body and/or the cooling element preferably consist/consists of at least one ceramic component or a composite of different ceramic materials.

The invention is explained in greater detail with reference to an exemplary embodiment. It presents a component 1 which has a ceramic body 2 which in accordance with the invention is not plate-shaped. Being not plate-shaped means that the upper side 3 and the lower side 4 of the ceramic body 2 are formed in such a way that they each have surfaces of differing size. The body is spatially structured. The upper side 3 of the component 1 in the present exemplary embodiment has a planar surface. Various metallized regions 5 are put on this upper side 3. The upper side 3 is a circuit-carrier. Applied to at least one metallized coating 5 on the upper side 3 of the ceramic body 2 there is at least one further metallized coating 6 which in the present case covers over part of the surface of the first metallized coating 5.

In the present exemplary embodiment the ceramic body 2 is E-shaped. The body is a heat sink. The lower side 4 of the ceramic body 2 has cooling ribs 7. The cooling ribs 7 are also provided with metallized regions 5 onto which electronic components, for example, can be soldered. On the surface 3 of the ceramic body 2 a chip 8 is secured on a metallized region 5 by means of a soldered connection 9. It is connected to a metallized region 5 by way of leads 10. This chip 8 represents a heat source, the heat of which is dissipated by way of the cooling ribs 7.

If a metallized coating of copper is to be applied to an aluminium-nitride ceramic material by means of the DCB method, it is advantageous if there is an intermediate layer of Al₂O₃ on the surface of the ceramic body. In the present exemplary embodiment this is shown on the left-hand side of the ceramic body 2 on a cooling rib 7. Assuming that the body 2 consists of aluminium nitride, an intermediate layer 12 of Al₂O₃ has been produced between the metallized coating of copper 11 and the surface of the ceramic body 2. An electronic component 14 is connected to the metallized coating of copper 11 by means of a solder 13.

1. A component having a ceramic body which is covered in at least one region on its surface with a metallized coating, wherein the partial-discharge resistance between at least two layers of a metallized coating of the same kind of or different materials as well as between the layer of a metallized coating and the ceramic material is <20 pC, and in that the ceramic body is spatially structured.

2. A component according to claim 1, wherein defects forming cavities at the transition between two metallized coatings, at the transition between a metallized coating and the ceramic body and also at the transition between a connected component and the metallized coating do not go beyond a diameter of 100 μm and a height of 100 μm.

3. A component according to claim 1, wherein defects formed by the structured metallized coating in the form of projections or recesses on the surface of the component have an edge course whose radius of curvature does not fall short of 10 μm.

4. A component according to claim 1, wherein metals in the form of coatings or foils or metal sheets are connected as the metallized coating to the ceramic body over the whole or part of the surface in a substance-locking manner or by means of mechanical form-locking, the metals having the same or different thermal conductivity as or from the carrier body.

5. A component according to claim 1, wherein the metallized coating consists of tungsten, silver, gold, copper, platinum, palladium, nickel, aluminium or steel of pure or industrial quality or of mixtures of at least two different metals or, additionally or merely, consists of reaction solders, soft solders or hard solders.

6. A component according to claim 1, wherein adhesion-promoting substances or other additives are added to or used to coat the metals of the metallized coating in the form of coatings or foils or metal sheets.

7. A component according to claim 1, wherein the metallized coating on the ceramic body consists of at least one layer, and in that this layer is put on the surface of the body on opposing or adjacent faces with the use of a Direct Copper Bonding (DCB) method or an Active Metal Brazing (AMB) method or a screen-printing method or an electrolytic method or chemical deposition or a vaporization method or by means of adhesion or gluing or a combination of these methods.

8. A component according to claim 1, wherein the metallized coating as a metal body covers over the surface of the ceramic body over part of or the whole surface or partly or completely in a plane-parallel or almost plane-parallel form or in a manner protruding in any geometrical form or in combinations of the forms.

9. A component according to claim 1, wherein applied to at least one metallized coating on the ceramic body there is at least one further metallized coating which covers over part of or the whole surface thereof.

10. A component according to claim 1, wherein the layer thickness of a metallized coating lies below 2 mm.

11. A component according to claim 1, wherein one or more metallized coatings on the ceramic body comprises or consists of copper, and in that the connection with the ceramic body is effected by means of the screen-printing method with subsequent thermal treatment or the DCB method.

12. A component according to claim 1, wherein one or more metallized coatings on the ceramic body is or are just of aluminium, and in that the connection with the ceramic body is effected by means of the screen-printing method with subsequent thermal treatment or the AMB process.

13. A component according to claim 1, wherein the binding of the at least one metallized coating or a further metallized coating to the ceramic body is greater than 90%.

14. A component according to claim 1, wherein the at least one metallized coating is connected to the ceramic body with an adhesive strength of at least 12 N/cm.

15. A component according to claim 1, wherein the thickness of a layer of the metallized coating amounts to ≦2 mm.

16. A component according to claim 1, wherein an intermediate layer is put on at least one surface of the ceramic body or a metallized coating for promoting the adhesion of a further layer or a component.

17. A component according to claim 16, wherein the thickness of the intermediate layer amounts to ≦20 μm.

18. A component according to claim 16, wherein the intermediate layer comprises Al₂O₃.

19. A component according to claim 1, wherein the ceramic material contains as a main component 50.1% by weight to 100% by weight ZrO₂/HfO₂ or 50.1% by weight to 100% by weight Al₂O₃ or 50.1% by weight to 100% by weight AlN or 50.1% by weight to 100% by weight Si₃N₄ or 50.1% by weight to 100% by weight BeO, 50.1% by weight to 100% by weight SiC or a combination of at least two of the main components in any combination in the specified range of proportions and also as a secondary component the elements Ca, Sr, Si, Mg, B, Y, Sc, Ce, Cu, Zn, Pb in at least one oxidation stage or compound with a proportion of ≦49.9% by weight individually or in any combination in the specified range ofproportions, and in that the main components and the secondary components, with removal of a proportion of impurities of ≦3% by weight, can be combined with each other in any combination with each other to give a total composition of 100% by weight.

20. A component according to claim 1, wherein the ceramic body, provided with cooling ribs, is formed as a heat sink.
